(19) United States
(12) Patent Application Publication
(10) Pub. No.: US 2026/0103577 A1
(43) Pub. Date: Apr. 16, 2026

(54) METHOD FOR PASSIVATING END GROUP OF FLUOROELASTOMER

(71) Applicant: SHANGHAI MORISEAL NEW MATERIAL TECHNOLOGY CO., LTD., Shanghai (CN)

(72) Inventors: Jiazhuang SHANG, Shanghai (CN); Guohua XIU, Shanghai (CN)

(73) Assignee: SHANGHAI MORISEAL NEW MATERIAL TECHNOLOGY CO., LTD., Shanghai (CN)

(21) Appl. No.: 19/102,820

(22) PCT Filed: Jun. 29, 2023
(86) PCT No.: PCT/CN2023/103651

§ 371 Date: Feb. 10, 2025

(30) Foreign Application Priority Data
Jun. 14, 2023 (CN) 202310699056.X

(51) Int. Cl. C08J 7/12; C08J 7/02

(52) U.S. Cl. CPC C08J 7/126; C08J 7/02; C08J 7/12; C08J 2327/16; C08J 2371/02

(57) ABSTRACT

Provided in the present application is a method for passivating an end group of a fluoroelastomer, which method is applied to the technical field of fluoroelastomers. The method comprises: S1, subjecting a fluoroelastomer to a devolatilization treatment by using a liquid or a supercritical fluid; S2, subjecting the devolatilized fluoroelastomer to a passivation treatment, and removing a passivation medium; and S3, washing the fluoroelastomer with deionized water, dehydrating the fluoroelastomer, and then drying same to obtain a devolatilized and passivated fluoroelastomer. By passivating the fluoroelastomer after liquid or supercritical fluid devolatilization, the obtained fluoroelastomer has less volatile components; by controlling the concentration of the passivation medium and the passivation time so as to control and adjust the end group passivation degree or the end group stabilization degree, the passivated fluoroelastomer has good processability and storage stability, and does not change color when in contact with a high-temperature and oxidation environment.

### TECHNICAL FIELD

The invention relates to the technical field of fluoroelastomers, in particular to a method for passivating an end group of fluoroelastomer.

### BACKGROUND ART

Fluoroelastomer product is a kind of multifunctional multipurpose sealing material. In high precision chip production, trace impurities will greatly reduce the performance of the product. Only ultra-clean environment can meet the demand of semiconductor industries. Therefore, fluoroelastomer products used in semiconductor processing must not only have excellent chemical resistance, thermal stability and mechanical properties, but also have low content of extractables, low gas release and low permeability.

However, in practical applications, fluoroelastomers with the same chemical composition often have very different processing and application properties, and are not even suitable for practical applications. The main factors that affect the processing and application properties of fluoroelastomers and the physical properties of products are chemical composition, chemical structure and physical morphology of polymers, and the end groups of fluoroelastomers.

Whether the end group is stable depends on its chemical structure and depends on polymerization chemistry and specific polymerization conditions. According to different polymerization conditions such as the type of polymerization initiator and the type of chain transfer agent used in the polymerization of fluoroelastomers, in addition to generating stable terminal trifluoromethyl —CF₃, there are also unstable terminal groups such as carboxylic acid —COOH, acyl fluoride —COF, hydroxymethyl —CH₂OH, ester functional group —COOCH₃, etc. These unstable end groups will decompose in the subsequent high-temperature process, and the released gas will generate bubbles, which will adversely affect the processing and physical properties of products. The prepared sealing element product can slowly decompose unstable end groups when applied to a semiconductor process, precipitate pollutants such as fluorine ions and the like, pollute the semiconductor process, and affect the quality of semiconductor components.

In addition, the perfluoroether elastomer should also remove the initiator, chain transfer agent, emulsifier and other components added in the polymerization process. If the perfluoroether elastomer contains a small amount of residue of these components, it is easy to cause yellowing in the subsequent process and application.

As well-known, in the production of thermoplastic resin PFA (perfluoroalkoxy vinyl ether polymer), aqueous phase polymerization is followed by coagulation. The coagulated powdered resin is washed with deionized water and dried and devolatilized at a temperature of up to 280° C. to remove water in the polymer, as well as initiator, chain transfer agent, surfactant and small molecular polymer. The dried and devolatilized resin has good fluidity.

The thermal stability of the end groups is generally arranged in the following order: —CF₃>—CONH₂>—COOCH₃>—CH₂OH>—COF. Therefore, the end group passivation is to change unstable end groups into stable end groups through chemical treatment. For example, PFA resin uses 1-10% fluorine gas (with nitrogen as the balance gas) for end group passivation (conversion to stable end group —CF₃) and/or 50% NH₃ amination (conversion to stable end group —CONH₂) to finally obtain transparent PFA powder resin with stable processing.

Patent Document JPS62-104822 describes a method for passivating PFA end groups, which includes contacting a specific TFE-PAVE copolymer with a fluorine-containing gas at a temperature, time and pressure sufficient to remove all unstable end groups, and purging the copolymer with an inert gas to remove unstable end groups.

Patent Document JPH04-20507 describes another PFA end group passivation method, which includes contacting a specific TFE-PAVE copolymer with fluorine gas to obtain a total number of 7 to 40 —COF groups per 10⁶ carbon atoms, and then further completely converting the —COF groups into —CONH₂ groups with ammonia gas.

U.S. Pat. No. 7,754,821B2 provides a method for end group passivation of fluorine-containing thermoplastic polymers under mild conditions.

Different from the treatment method of thermoplastic resins such as PFA, fluoroelastomers such as perfluoroether elastomers become viscous when dried at a lower temperature (e.g., 120° C.), the particles adhere to each other, the void ratio decreases, and the pressure difference and mass transfer resistance increase, so that the initiator, chain transfer agent, surfactant and small molecular polymer encapsulated therein cannot be completely removed, i.e., cannot be effectively devolatilized, and cannot be subjected to subsequent effective end group passivation treatment. Perfluoroether elastomers produced in China and abroad show yellow or amber color after high temperature treatment.

### SUMMARY OF THE INVENTION

In view of this, the embodiment of the specification provides a method for passivating end groups of fluoroelastomers. The fluoroelastomers are devolatilized by using liquid or supercritical fluid, and then passivated, washed and dried to obtain devolatilized and passivated fluoroelastomers.

The embodiment of the specification provides the following technical solution: A method for passivating an end group of fluoroelastomer comprising the following steps of
S1, subjecting a fluoroelastomer to a devolatilization treatment by using a liquid or a supercritical fluid, wherein the fluoroelastomer is a perfluoroether elastomer or a fluoroelastomer containing vinylidene fluoride;
S2, subjecting the devolatilized fluoroelastomer to a passivation treatment, and removing a passivation medium;
S3, washing the fluoroelastomer with deionized water, dehydrating the fluoroelastomer, and then drying same to obtain a devolatilized and passivated fluoroelastomer.

Optionally, before devolatilization of the fluoroelastomer, the fluoroelastomer emulsion prepared by aqueous medium polymerization is coagulated, washed and centrifugally dehydrated.

Optionally, in S1, the fluoroelastomer is subjected to vacuum drying or freeze drying before devolatilization.

Optionally, in S1, the liquid or supercritical fluid is CO₂.

Optionally, in S1, the liquid or supercritical fluid contains an entrainer, and the entrainer comprises one or more of methanol, ethanol, isopropanol, acetone, chloroform, hexane and trichloroethane.

Optionally, in S1, the entrainer is used in an amount of 0.5% to 10.0% by mass of CO₂.

Optionally, in S2, the fluoroelastomer is passivated by fluorination, and the fluorinating agent comprises one or more of F₂, NF₃, SF₄, PF₅, IF₅ and IF₇.

Optionally, in S2, the fluoroelastomer is passivated by amination, and the amination agent comprises one or more of NH₃, ammonium carbonate, ammonium bicarbonate, ammonium carbamate, ammonium oxalate, ammonium sulfamate, ammonium formate, ammonium thiocyanate and ammonium sulfate.

Optionally, in S2, the fluoroelastomer is fluorinated and then aminated.

Optionally, in S2, the fluorination is followed by a replacement with an inert medium, and the inert medium replacement is followed by the amidation, wherein the inert medium is N₂ or CO₂.

Optionally, the fluorination concentration is 1-10 wt %, and the balance gas is N₂ or CO₂.

Optionally, the concentration of the amination medium is 10-60 wt %, and the balance gas of the gaseous amination medium is N₂, and the solution of the liquid amination medium is an aqueous solution.

Optionally, the temperature of the fluorination passivation is 60-200° C.

Optionally, the temperature of amination passivation is 0° C. to 100° C.

Optionally, the passivation medium introduced per unit mass of polymer is accumulated to 1-10 g/kg polymer.

Compared with the prior art, the beneficial effects of the at least one technical solution adopted in the embodiment of the specification at least include the following. According to the application, the fluoroelastomer is passivated after devolatilization with liquid or supercritical fluid, the obtained fluoroelastomer has less volatile components; the passivation degree or the stabilization degree of the end group is further controlled and adjusted by controlling the concentration of the passivation medium and the passivation time. The fluoroelastomer does not change color when in contact with a high-temperature and oxidation environment during the subsequent processing and using processes, and in addition, partial active end groups are used for secondary vulcanization to form a network structure, such that the mechanical performance is good, the compression set is low, and a product of the fluoroelastomer can be applied to the manufacturing process of a high-cleanliness semiconductor.

### BRIEF DESCRIPTION OF DRAWINGS

In order to explain the technical solution of the embodiment of the application more clearly, the following will briefly introduce the drawings needed in the embodiment. Obviously, the drawings in the following description are only some embodiments of the application. For those skilled in the art, other drawings can be obtained according to these drawings without inventive labor.

FIG. 1 is a flow chart of the method for passivating an end group of fluoroelastomer according to the present application.

### DETAILED DESCRIPTION OF THE PREFERRED EMBODIMENT

Hereinafter, embodiments of the present application will be described in detail with reference to the accompanying drawings.

The embodiments of the present application are described below by specific examples, and other advantages and effects of the application can be easily understood by those skilled in the art from the disclosure of the present specification. Obviously, the described embodiments are only some embodiments of the present application, not all embodiments. This application can also be implemented or applied through different specific embodiments of in addition. The details in this specification can also be modified or changed based on different viewpoints and applications without departing from the spirit of this application. It should be noted that the following embodiments and the features in the embodiments can be combined with each other without conflict. Based on the embodiments in this application, all other embodiments obtained by ordinary technicians in this field without inventive labor are within the scope of protection in this application.

It is to be noted that various aspects of embodiments within the scope of the appended claims are described below. It should be apparent that the aspects described herein may be embodied in a wide variety of forms, and any specific structures and/or functions described herein are merely illustrative. Based on this application, those skilled in the art will appreciate that one aspect described herein may be implemented independently of any other aspect, and two or more of these aspects may be combined in various ways. For example, devices and/or practical methods may be implemented using any number and aspects set forth herein. In addition, the apparatus may be implemented and/or the method practiced using other structures and/or functionality than one or more of the aspects set forth herein.

It should also be noted that the diagrams provided in the following examples only illustrate the basic concept of this application in a schematic way. Only the components related to this application are shown in the drawings, instead of being drawn according to the number, shape and size of components in actual implementation. The type, number and proportion of components in actual implementation can be arbitrarily changed, and the component layout type may be more complicated.

In addition, in the following description, specific details are provided to facilitate a thorough understanding of the examples. However, one skilled in the art will understand that the present invention may be practiced without these specific details.

Fluoroelastomer product is a multi-functional multi-purpose sealing material. In high precision chip production, trace impurities will greatly reduce the performance of the product. Only ultra-clean environment can meet the demand of semiconductor industries. fluoroelastomer products used in semiconductor processing must not only have excellent chemical resistance, thermal stability and mechanical properties, but also have low content of extractables, low gas release and low permeability.

The stability of end group of fluoroelastomer is determined by their chemical structure. These unstable end groups will decompose in the subsequent high-temperature processing, and the released gas will generate bubbles, which will adversely affect the processing and physical properties of products. The prepared sealing element product can slowly decompose unstable end groups when applied to a semiconductor process, precipitate pollutants such as fluorine ions and the like, pollute the semiconductor process, and affect the quality of semiconductor components. The fluoroether elastomer should also remove the initiator, chain transfer agent, emulsifier and other components added in the polymerization process. If the perfluoroether elastomer contains a small amount of residue of these components, it is easy to undergo yellowing and oxidation in the subsequent process and application.

Fluoroelastomers include vinylidene fluoride-containing fluoroelastomers, perfluoroether elastomers, fluorosilicone elastomers, fluorophosphazene-containing elastomers, and the like, wherein common fluoroelastomers represented by vinylidene fluoride-containing fluoroelastomers contain hydrocarbon groups. Perfluoroether elastomer is mainly formed by copolymerizing tetrafluoroethylene, perfluoroalkyl vinyl ether (including perfluoromethyl vinyl ether PMVE and perfluoropropyl vinyl ether PPVE) as main monomers and a small amount of third monomers with vulcanization points, i.e., the cure site monomer. All hydrogen atoms on all carbon atoms in the polymer are replaced by fluorine atoms. The products thereof have a stable structure that is resistant to high temperatures and chemicals, such as polytetrafluoroethylene (PTFE) high temperature stability, and can also resist the corrosion of more than 1600 chemicals. Its excellent performance helps to maintain the integrity of sealing and reduce maintenance times.

Different from the treatment method of thermoplastic resins such as PFA, fluoroelastomers such as perfluoroether elastomers become viscous when dried at a lower temperature (e.g., 120° C.), the particles adhere to each other, the void ratio decreases, and the pressure difference and mass transfer resistance increase, so that the initiator, chain transfer agent, surfactant and small molecular polymer encapsulated therein cannot be completely removed, i.e., cannot be effectively devolatilized, and cannot be subjected to subsequent effective end group passivation treatment. Perfluoroether elastomers produced at home and abroad show yellow or amber color after high temperature treatment.

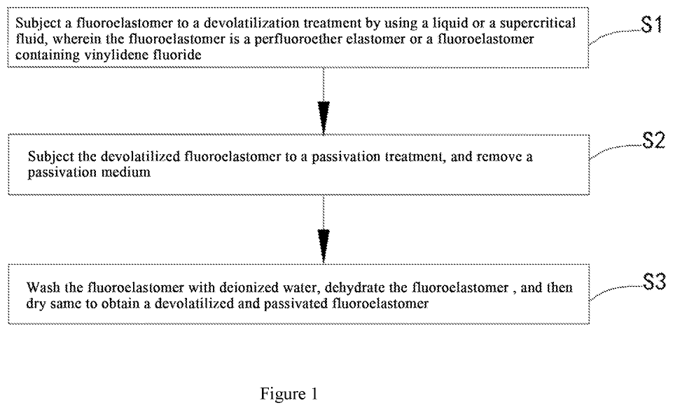

Based on this, the embodiment of the specification provides a method for passivating an end group of fluoroelastomer. As shown in FIG. 1, the method comprises the following steps.
Step S1, performing coagulation, washing and centrifugal dehydration treatment on the fluoroelastomer emulsion prepared by polymerization in an aqueous medium, so as to granulate the coagulated dispersion liquid, at the same time prevent from agglomerating, and generate polymer particles with a size of about 0.01 mm to 1 mm, so as to facilitate removal of free water and part of bound water contained in the fluoroelastomer and prevent most particles from adhering to each other; performing vacuum drying or freeze drying treatment on the fluoroelastomer, and performing devolatilization treatment on the fluoroelastomer by using liquid or supercritical CO₂, wherein the fluoroelastomer is specifically perfluoroether elastomer or fluoroelastomer containing vinylidene fluoride;
Step S2, subjecting the devolatilized fluoroelastomer to a passivation treatment, wherein the total amount of passivating medium introduced per unit mass of polymer is 1 g-10 g/kg polymer, and removing the passivating medium;
Step S3, washing the fluoroelastomer with deionized water, dehydrating the fluoroelastomer, and then drying same to obtain a devolatilized and passivated fluoroelastomer.

In step S1, the fluoroelastomer prepared by aqueous medium polymerization is perfluoroether elastomer and/or fluoroelastomer containing vinylidene fluoride.

In step S1, the liquid or supercritical fluid CO₂ contains an entrainer, and the entrainer comprises one or more of methanol, ethanol, isopropanol, acetone, chloroform, hexane and trichloroethane, and the amount of the entrainer is 0.5%-10.0% of the mass of CO₂. The entrainer can enhance the selectivity, solubility and extraction efficiency of CO₂ extraction process. It can be miscible with the fluid solvent and has a volatility between the extracted substance and supercritical components, so as to increase its selectivity and solubility to the extracted components.

In step S2, the fluoroelastomer is passivated by fluorination, and the fluorinating agent comprises one or more of F₂, NF₃, SF₄, PF₅, IF₅ and IF₇. The fluorination concentration is 1-10 wt %, and balance gas is N₂ or CO₂. The temperature of fluorination passivation is 60-200° C.

In step S2, the fluoroelastomer is fluorinated and aminated. The fluorination is followed by a replacement with an inert medium, and the inert medium replacement is followed by the amidation, wherein the inert medium is N₂ or CO₂. The fluoroelastomer is passivated by amination, and the amination agent comprises one or more of NH₃, ammonium carbonate, ammonium bicarbonate, ammonium carbamate, ammonium oxalate, ammonium sulfamate, ammonium formate, ammonium thiocyanate and ammonium sulfate. The concentration of the amination medium is 10-60 wt %, and the balance gas of the gaseous amination medium is nitrogen, and the solution of the liquid amination medium is an aqueous solution. The temperature of amination passivation is 0-100° C.

### Example 1

10 L perfluoroether elastomer emulsion prepared by aqueous medium polymerization with a solid content of about 28% was diluted by deionized water (conductivity 0.1-1.0 μs/cm; 25° C.) to 15 L. The electrolyte MgCl₂ with a solid content of 1.5 wt % was added under stirring for coagulation. The mixture was stirred vigorously during coagulation to prevent agglomeration, with a particle size of 0.01 mm to 1 mm. The mixture was repeatedly washed and soaked with deionized water, centrifugally dewatered, and dried at 40° C. for 24 h in a rotary vacuum drying oven with an absolute pressure of 0.01 MPa. The obtained dried polymer micropowder had a mass of w₁.

Supercritical CO₂ was used as extractant, and ethanol entrainer was added by plunger pump. The mass was about 8% of the mass of CO₂.

The vacuum dried powder was put into a stainless steel inner cylinder, which adopted a 2000-mesh stainless steel screen (Taylor mesh, about 6.5 microns). The inner cylinder was placed in an extraction device, and the gap between the inner cylinder and the extraction device was sealed by a PTFE sealing gasket.

The temperature and pressure of supercritical CO₂ were 85° C., 12 MPa respectively, and the apparent flow rate of CO₂ was 0.05 m/s. GC-MS (Agilent 8860-5977B) was used to detect the concentration of organic matter in tail gas. When the concentration of organic matter was less than 0.01 mg/kg, devolatilization was stopped. The pressure was released and the system was purged. The stainless steel inner cylinder was taken out to obtain the devolatilized polymer micropowder with a mass of w₂.

The fluorination treatment was conducted under ambient pressure. Firstly, N₂ was introduced, and 3.0 wt % and 8.0 wt % (N₂ balance) of fluorine gas were successively introduced for fluorination treatment at a fluorination temperature of 100° C. and a flow rate of 0.2 L/min. After fluorination treatment, N₂ was replaced to purge and remove the retained fluorine-containing gas to obtain devolatilized and fluorinated perfluoroether elastomer. The amount of fluorine gas introduced per unit mass of polymer was approximately 1.5-4.1 g/kg polymer.

The perfluoroether elastomer product was washed in deionized water at 90° C., centrifugally dewatered and dried in a vacuum drying oven to obtain the devolatilized fluorinated perfluoroether elastomer product with a mass of w₃. The functional groups on the fluoroelastomer surface were detected by microscopy-infrared spectrometer (Shimadzu ATM9000).

### Example 2

The difference between this example and Example 1 is in the extract and devolatilization process. The fluoroelastomer was a fluoroelastomer containing vinylidene fluoride. The entrainer was methanol. In the fluorination passivation process, the fluorinating agent was SF₄, and N₂ was balance gas, and the fluorination temperature was 120° C. to obtain the devolatilized and fluorinated vinylidene fluoride-containing fluoroelastomer.

### Example 3

The difference between this example and Example 1 is in the extract and devolatilization process. The entrainer was methanol. In the fluorination passivation process, the fluorinating agent was IF₇, and N₂ was balance gas, and the fluorination temperature was 70° C. to obtain the devolatilized and fluorinated perfluoroether elastomer.

### Example 4

The difference between this example and Example 1 is in the extract and devolatilization process. The entrainer was ethanol. In the fluorination passivation process, the fluorinating agent was NF₃, and CO₂ was balance gas, and the fluorination temperature was 120° C. to obtain the devolatilized and fluorinated perfluoroether elastomer.

The functional groups on the fluoroelastomer surface were detected by microscopy-infrared spectrometer (Shimadzu ATM9000). In the deionized water leaching experiments, fluorine ion content was measured by fluoride ion electrode (METTLER, SD50F-Ionik ID). The end group number after fluorination was measured by FTIR (Shimadzu). The weight loss was measured by balance (Shimadzu, precision 0.1 mg).

TABLE 1
Performance Test Results of Examples 1-4 (Fluoride Gas Flow Rate: 0.2 L/min)

| | | Accumulated | | | | |
|---|---|---|---|---|---|---|
| | | F₂ amount or | | | | |
| | | fluorine- | | End group | | |
| | | containing | | numbers after | | Fluorine ion |
| | | gas amount | Weight | fluorination, ppm | | number |
| | w1, | g/kg | loss (w₁- | (1/10⁶) | | extracted, ppm |
| Example | (kg) | polymer | w₃)/w₁, % | —COF | —COOF | (1/10⁶) |
| 1 | 2.80 | 3.2 | 4.2 | 57 | 3 | 98 |
| 2 | 2.65 | 5.8 | 5.3 | 32 | 2 | 24 |
| 3 | 2.92 | 3.9 | 5.2 | 37 | 2 | 65 |
| 4 | 2.73 | 6.5 | 5.7 | 22 | 4 | 18 |

The fluoroelastomers of Examples 1˜4 of the above fluorination passivation were continuously aminated, and the corresponding examples are Examples 5-8 respectively.

### Example 5

Firstly, inert medium N₂ was introduced, and then ammonia gas with a concentration of 30 wt % and 50 wt % was switched for amination treatment. The balance gas was nitrogen, the amination temperature was 50° C., and the flow rate was 0.2 L/min. The amount of ammonia introduced per unit mass of polymer (mass flowmeter; West Neil) accumulated to 5 g/kg polymer to 8 g/kg polymer. After amination, N₂ was replaced to purge and remove the retained ammonia-containing gas, thus obtaining the fluorinated and aminated fluoroelastomer.

The fluoroelastomer product was placed in deionized water for cleaning treatment, centrifuged and dehydrated, and dried in a vacuum environment to obtain aminated and dried fluoroelastomer product with a mass of w₄. In a specific embodiment of the present invention, the temperature of deionized water was 80-98° C., and the time of washing and soaking treatment was 18 h.

### Example 6

The difference between this example and Example 5 is in the amidation and passivation process. The inert medium was deionized water. The aminating agent was ammonium carbonate. The amination temperature was 80° C. After amination, the deionized water was replaced to remove the retained ammonium carbonate-containing solution, thus obtaining the fluorinated and aminated fluoroelastomer.

### Example 7

The difference between this example and Example 5 is in the amidation and passivation process. The inert medium was deionized water. The aminating agent was ammonium oxalate. The amination temperature was 70° C. After amination, the deionized water was replaced to remove the retained ammonium oxalate-containing solution, thus obtaining the fluorinated and aminated fluoroelastomer.

### Example 8

The difference between this example and Example 5 is in the amidation and passivation process. The inert medium was deionized water. The aminating agent was ammonium sulfate. The amination temperature was 80° C. After amination, the deionized water was replaced to remove the retained ammonium sulfate-containing solution, thus obtaining the fluorinated and aminated fluoroelastomer.

The functional groups on the fluoroelastomer surface were detected by microscopy-infrared spectrometer (Shimadzu ATM9000). In the deionized water leaching experiments, fluorine ion content was measured. The experiment was carried out in a PTFE-lined 100 ml high-pressure reactor (Ibell). The temperature was kept constant for 48 hours in a thermostatic chamber (Shanghai Yiheng BPG-9106B). Fluorine ion content was measured by a fluoride ion electrode (METTLER, SD50 F-ion Kid).

TABLE 2
Performance Test Results of Examples 5-8

| | Accumulated | | | | |
|---|---|---|---|---|---|
| | NH₃ amount | | | | |
| | or amine- | | | | |
| | containing | | End group numbers | | Fluorine |
| | solution | Weight loss | after amidation, | | ion number |
| Exam- | amount g/kg | (w₃-w₄)/w₃, | ppm (1/10⁶) | | extracted, |
| ple | polymer | % | —CONH₂ | —COF | ppm (1/10⁶) |
| 5 | 5.2 | 1.1 | 75 | 0 | 10 |
| 6 | 8.9 | 1.7 | 91 | 0 | 6 |
| 7 | 6.8 | 1.4 | 76 | 0 | 7 |
| 8 | 10.7 | 2.1 | 127 | 0 | 3 |

Comparative Example 1 was a perfluoroether elastomer without devolatilization and passivation treatment.

10 L perfluoroether elastomer emulsion prepared by aqueous medium polymerization with a solid content of about 28% was diluted by deionized water (conductivity 0.1-1.0 μs/cm; 25° C.) to 15 L. The electrolyte MgCl₂ with a solid content of 1.5 wt % was added under stirring for coagulation. The mixture was stirred vigorously during coagulation to prevent agglomeration, with a particle size of 0.01 mm to 1 mm. The mixture was repeatedly washed and soaked with deionized water, centrifugally dewatered, and dried at 40° C. for 24 h in a rotary vacuum drying oven with an absolute pressure of 0.01 MPa. The dry agglomerated polymer was obtained with apparent density of 1.030-1.052, which was about half of the true density.

The functional groups on the fluoroelastomer surface were detected by microscopy-infrared spectrometer (Shimadzu ATM9000). In the deionized water leaching experiments, fluorine ion content was measured. The experiment was carried out in a PTFE-lined 100 ml high-pressure reactor (Ibell). The temperature was kept constant for 48 hours in a thermostatic chamber (Shanghai Yiheng BPG-9106B). Fluorine ion content was measured by a fluoride ion electrode (METTLER, SD50 F-ion Kid).

Table 3 shows directly dried perfluoroether elastomers without devolatilization and fluorination (absolute pressure 0.01 MPa).

| | Unstable end group | | Fluorine ion |
|---|---|---|---|
| Comparative | number, ppm (1/10⁶) | | number extracted, |
| Example | —COF | —COOF | ppm (1/10⁶) |
| 1 | 461 | 85 | 420 |

By comparing Table 1, Table 2 and Table 3, it can be seen that the weight loss of low molecular polymer in perfluoroether elastomer was not large due to lower operating temperature and long devolatilization time. After fluorination treatment, unstable end groups were reduced by more than 90%. After end group passivation treatment, especially amination, unstable end group —COF was basically eliminated to generate stable end group —CONH₂. The invention can adjust the passivation degree by adjusting the passivation time and/or the concentration of the passivation medium and/or the passivation temperature.

In this specification, the same and similar parts between various embodiments can be referred to each other. Each embodiment focuses on the differences from other embodiments. In particular, for the embodiment described later, the description is relatively simple, and the relevant parts can be found in the partial description of the previous embodiment.

The above description is only a specific embodiment of the present application, but the scope of protection of the present application is not limited to this. Any changes or substitutions that can easily occur to those skilled in the art within the technical scope disclosed in the present application should be covered within the scope of protection of the present application. Therefore, the scope of protection of this application shall be subject to that of the claims.

1. A method for passivating an end group of fluoroelastomer comprising the following steps of
S1, subjecting a fluoroelastomer to a devolatilization treatment by using a liquid or a supercritical fluid, wherein the fluoroelastomer is a perfluoroether elastomer or a fluoroelastomer containing vinylidene fluoride;
S2, subjecting the devolatilized fluoroelastomer to a passivation treatment, and removing a passivation medium;
S3, washing the fluoroelastomer with deionized water, dehydrating the fluoroelastomer, and then drying same to obtain a devolatilized and passivated fluoroelastomer.

2. The method for passivating an end group of fluoroelastomer according to claim 1, characterized in that, before devolatilization of the fluoroelastomer, the fluoroelastomer emulsion prepared by aqueous medium polymerization is coagulated, washed and centrifugally dehydrated.

3. The method for passivating an end group of fluoroelastomer according to claim 1, characterized in that, in S1, the fluoroelastomer is subjected to vacuum drying or freeze drying before devolatilization.

4. The method for passivating an end group of fluoroelastomer according to claim 1, characterized in that, in S1, the liquid or supercritical fluid is CO₂.

5. The method for passivating an end group of fluoroelastomer according to claim 4, characterized in that, in S1, the liquid or supercritical fluid contains an entrainer, and the entrainer comprises one or more of methanol, ethanol, isopropanol, acetone, chloroform, hexane and trichloroethane.

6. The method for passivating an end group of fluoroelastomer according to claim 5, characterized in that, in S1, the entrainer is used in an amount of 0.5% to 10.0% by mass of CO₂.

7. The method for passivating an end group of fluoroelastomer according to claim 1, characterized in that, in S2, the fluoroelastomer is passivated by fluorination, and the fluorinating agent comprises one or more of F₂, NF₃, SF₄, PF₅, IF₅ and IF₇.

8. The method for passivating an end group of fluoroelastomer according to claim 1, characterized in that, in S2, the fluoroelastomer is passivated by amination, and the amination agent comprises one or more of NH₃, ammonium carbonate, ammonium bicarbonate, ammonium carbamate, ammonium oxalate, ammonium sulfamate, ammonium formate, ammonium thiocyanate and ammonium sulfate.

9. The method for passivating an end group of fluoroelastomer according to claim 1, characterized in that, in S2, the fluoroelastomer is fluorinated and then aminated.

10. The method for passivating an end group of fluoroelastomer according to claim 9, characterized in that, in S2, the fluorination is followed by a replacement with an inert medium, and the inert medium replacement is followed by the amidation, wherein the inert medium is N₂ or CO₂.

11. The method for passivating an end group of fluoroelastomer according to claim 7, characterized in that, the fluorination concentration is 1-10 wt %, and the balance gas is N₂ or CO₂.

12. The method for passivating an end group of fluoroelastomer according to claim 8, characterized in that, the concentration of the amination medium is 10-60 wt %, and the balance gas of the gaseous amination medium is N₂, and the solution of the liquid amination medium is an aqueous solution.

13. The method for passivating an end group of fluoroelastomer according to claim 7, characterized in that, the temperature of the fluorination passivation is 60-200° C.

14. The method for passivating an end group of fluoroelastomer according to claim 8, characterized in that, the temperature of amination passivation is 0° C. to 100° C.

15. The method for passivating an end group of fluoroelastomer according to claim 7, characterized in that, the passivation medium introduced per unit mass of polymer is accumulated to 1-10 g/kg polymer.

16. The method for passivating an end group of fluoroelastomer according to claim 8, characterized in that, the passivation medium introduced per unit mass of polymer is accumulated to 1-10 g/kg polymer.
